(19) United States
(12) Patent Application Publication
(10) Pub. No.: US 2011/0306696 A1
(43) Pub. Date: Dec. 15, 2011

(54) Continuous Production of Copolymers Suitable as Flow Agents

(76) Inventors: Silke Flakus, Ebersberg (DE); Laurent Marc, Hericy (FR); Zhizhong Cai, Trostberg (DE); Helmut Mack, Traunstein (DE); Burkhard Walther, Garching (DE); Jochen Mezger, Garching an der Alz (DE); Simone Klapdohr, Rosenheim (DE); Tobias Austermann, Munster (DE)

(21) Appl. No.: 13/122,663

(22) PCT Filed: Oct. 8, 2009
(86) PCT No.: PCT/EP09/63070

§ 371 Date: Aug. 31, 2011

(30) Foreign Application Priority Data
Oct. 10, 2008 (EP) 08166298.3

(51) Int. Cl. C08F 2/48; C08K 3/34; C09D 133/02; C08F 220/06

(52) U.S. Cl. 522/3; 526/88; 524/5

(57) ABSTRACT

The invention relates to a process for the preparation of copolymers containing acid monomer structural units and polyether macromonomer structural units, which is carried out in a continuous mode of operation in a reactor which has
α) a body B rotating about an axis of rotation and having a reaction surface,
β) a metering system and
γ) a device for irradiating the reaction surface,
i) the components of a starting reaction composition being applied individually and/or as a mixture with the aid of the metering system in a thin film on an inner region of the reaction surface of the rotating body B so that the thin film flows over the reaction surface of the rotating body B to an outer region of the reaction surface of the rotating body B, the thin film on the reaction surface being electromagnetically irradiated by means of the device for the irradiation of the reaction surface,
ii) the thin film leaving the reaction surface as a reaction composition which has copolymer containing acid monomer structural units and polyether macromonomer structural units and
iii) the reaction composition being collected after leaving the reaction surface,
   an acid monomer, a polyether macromonomer and a photoinitiator being present as components of the starting reaction composition.

The present invention relates to a process for the preparation of copolymers containing acid monomer structural units and polyether macromonomer structural units, and a copolymer which can be prepared by this process and the use of the copolymer.

It is known that admixtures in the form of dispersants are often added to aqueous slurries of pulverulent inorganic or organic substances, such as clays, silicate powder, chalk, carbon black, crushed rock and hydraulic binders, for improving their workability, i.e. kneadability, spreadability, sprayability, pumpability or flowability. Such admixtures are capable of breaking up solid agglomerates, of dispersing the particles formed and in this way of improving the workability. This effect is utilized in particular in a targeted manner in the production of building material mixtures which contain hydraulic binders, such as cement, lime, gypsum, hemihydrate or anhydrite.

In order to convert these building material mixtures based on said binders into a ready-to-use, workable form, as a rule substantially more mixing water is required than would be necessary for the subsequent hydration or hardening process. The proportion of cavities which is formed in the concrete body by the excess water which subsequently evaporates leads to significantly poorer mechanical strengths and resistances.

In order to reduce this excess proportion of water at a specified processing consistency and/or to improve the workability at a specified water/binder ratio, admixtures, which are generally referred to as water reduction agents or plasticizers, are used. In particular, copolymers which are prepared by free radical copolymerization of acid monomers with polyether macromonomers are used in practice as such compositions.

In practice, the copolymerization is generally effected in the semibatch-procedure. WO 2005/075529 describes a semicontinuous preparation process for said copolymers, in which the polyether macromonomer is initially introduced and the acid monomer is then metered into the initially introduced mixture over time. Although the process described is already economical and high-performance plasticizers are obtained as a product of the process, there is still an aspiration to even further improve the quality of the product of the process and the cost-efficiency of the process.

The object of the present invention is therefore to provide an economical process for the preparation of copolymers which show good performance as dispersants for hydraulic binders, especially as plasticizers/water reduction agents.

This object is achieved by a process for the preparation of copolymers containing acid monomer structural units and polyether macromonomer structural units, which is carried out in a continuous mode of operation in a reactor which has
α) a body B rotating about an axis of rotation and having a reaction surface,
β) a metering system and
γ) a device for irradiating the reaction surface,
i) the components of a starting reaction composition being applied individually and/or as a mixture with the aid of the metering system in a thin film on an inner region of the reaction surface of the rotating body B so that the thin film flows over the reaction surface of the rotating body B to an outer region of the reaction surface of the rotating body B, the thin film on the reaction surface being electromagnetically irradiated by means of the device for the irradiation of the reaction surface,
ii) the thin film leaving the reaction surface as a reaction composition which has copolymer containing acid monomer structural units and polyether macromonomer structural units and
iii) the reaction composition being collected after leaving the reaction surface,
   an acid monomer, a polyether macromonomer and a photoinitiator being present as components of the starting reaction composition and the temperature of the reaction surface being 0 to 60° C.

Acid monomer is to be understood as meaning monomers which are capable of free radical copolymerization, have at least one carbon double bond, contain at least one acid function and react as an acid in an aqueous medium. Furthermore, acid monomer is also to be understood as meaning monomers which are capable of free radical copolymerization and have at least one carbon double bond and which, as a result of a hydrolysis reaction in an aqueous medium, form at least one acid function and react as an acid in an aqueous medium (example: maleic anhydride). In the context of the present invention, polyether macromonomers are compounds which are capable of free radical copolymerization and have at least one carbon double bond and at least two ether oxygen atoms, in particular with the proviso that the polyether macromonomer structural units present in the copolymer have side chains which contain at least two ether oxygen atoms.

The reactor in which the process according to the invention is carried out permits process management in which particularly efficient and uniform irradiation by the UV light is permitted owing to the formation of a very thin film on the disc. In addition particularly good mixing ratios within the film lead to intensive contact with the active species. Short and controllable residence times permit control via the molecular weight even at high viscosities, which has a positive effect on the product properties. Furthermore, positive properties, such as a short residence time, thorough mixing and high mass transfer, also lead to economic advantages. The process according to the invention offers the possibility of flexible and simple process optimization. The scale-up which is often problematic in process engineering is particularly simple owing to the simplicity and the usually relatively small size of the reactor used. Furthermore, it should be mentioned that both the capital costs and the maintenance costs (cleaning, etc.) of said reactor are very low. Moreover, the quality of the product obtained, i.e. of the copolymer-containing reaction composition, can easily be varied in a targeted manner by changing the process parameters (residence time, temperature, metering of the components of the starting reaction composition).

The rotating body B is preferably in the form of a rotating disc which has the reaction surface at the top and where the components of the starting reaction composition are applied individually and/or as a mixture with the aid of the metering system in a middle region as a thin film, and a wall surrounding the rotating disc is preferably present, by means of which the reaction composition is collected after leaving the reaction surface.

The one body B rotating about an axis of rotation and having a reaction surface is present in general as a horizontal rotating disc or a rotating disc deviating slightly (at an angle of up to about 30°) from the horizontal. Alternatively, this body B may also be vase-shaped, annular or conical. Usually, the body B has a diameter of 0.10 m to 3.0 m, preferably 0.20 m to 2.0 m and particularly preferably 0.20 m to 1.0 m. The reaction surface may be smooth or alternatively may have ripple-like or spiral mouldings which influence the residence time of the reaction mixture. Expediently, the body B is installed in a container resistant to the conditions of the process according to the invention.

Usually, the temperature of the reaction surface is between 5 and 45° C., preferably between 10 and 30° C. The temperature of the reaction surface is an important parameter which should be tailored by the person skilled in the art to other relevant influencing variables, such as residence time, type and amount of the components of the starting reaction mixture.

For example, the following photoinitiators are suitable:

From the manufacturer Ciba AG:
Irgacure® 369: 2-benzyl-2-dimethylamino-1-[4-(4-morpholinyl)phenyl]-1-butanone
Irgacure® 651: alpha,alpha-dimethoxy-alpha-phenylacetophenone
Irgacure® 2022: phosphine oxide, phenylbis(2,4,6-trimethylbenzoyl) (20%) and 2-hydroxy-2-methyl-1-phenyl-1-propanone (80%)
Irgacure® 2100: phosphine oxide
Irgacure® 819 DW phosphine oxide: phenylbis(2,4,6-trimethylbenzoyl) (45% solids dispersed in water)
Darocur® MBF: methyl benzoylformate
Irgacure® 2959: 1-(4-(2-hydroxyethoxy)phenyl)-2-hydroxy-2-methyl-1-propan-1-one

From the manufacturer Lamberti S.p.A.
Esacure KIP EM: oligo[2-hydroxy-2-methyl-1-[4-(1-methylvinyl)phenyl]propanone], emulsion in water based on 32% active photoinitiator
Esacure DP 250: 2,4,6-trimethylbenzoyldiphenylphosphine oxide+alpha-hydroxyketone+benzophenone derivative

As a rule, 0.1 to 0.0005, preferably 0.01 to 0.1, mol of photoinitiator is used per mole of acid monomer.

Usually, solvents are also used as components of the starting reaction composition. The use of water as a solvent is particularly expedient.

In a preferred embodiment, the device for the irradiation of the reaction surface is present as a UV lamp, by means of which the thin film on the reaction surface is electromagnetically irradiated with light in a wavelength range from 10 to 700 nm, preferably 280 to 400 nm.

Typically established process parameters are a layer thickness of the thin film applied by means of the metering system of 10 μm to 1.0 mm, preferably of 100 to 200 μm, and a frequency-average residence time of the components of the starting reaction composition on the reaction surface of 0.1 to 20 seconds, preferably of 1 to 10 seconds.

The speed of rotation of the body B and the metering rate of the components of the starting reaction mixture are variable. Usually, the speed of revolution in revolutions per minute is 1 to 20 000, preferably 100 to 5000 and particularly preferably 500 to 2000. The volume of the reaction mixture which is present on the rotating body B per unit area of the reaction surface is typically 0.1 to 10 mL/dm², preferably 1.0 to 5.0 mL/dm². The average residence time (frequency average of the residence time spectrum) of the reaction mixture is dependent, inter alia, on the size of the reaction surface, on the type and amount of the components of the starting reaction mixture, on the reaction surface and on the speed of revolution of the rotating body B and is usually 0.01 to 100 s, preferably 0.1 to 10 s, particularly preferably 1 to 10 s, and is therefore to be regarded as being extremely short. This ensures that the extent of the undesired secondary reactions is greatly reduced and products of uniform quality are produced. In particular, the molecular weight itself can be readily controlled in the case of high viscosities.

In a preferred embodiment, the metering system used enables the components of the starting reaction composition to be added at any positions of the reaction surface. A portion or the total components of the starting reaction composition can be premixed and only thereafter applied by means of the metering system to the reaction surface. Not rarely, the acid monomer and the polyether macromonomer are, however, applied separately, i.e. without premixing with one another, to the reaction surface.

The reaction surface can extend to further rotating bodies so that, before leaving the reaction surface of the rotating body B, the reaction composition reaches the reaction surface of at least one further rotating body having the reaction surface. The further rotating bodies expediently correspond in character to the body B. Typically, the body B practically feeds the further bodies with the reaction mixture, i.e. the thin film flows from the body B to at least one further body, and leaves this at least one further body in order then to be collected as reaction product.

As a rule, that acid monomer structural unit of the copolymer which arises from the reaction of the acid monomer is in accordance with one of the general formula (Ia), (Ib), (Ic) and/or (Id)

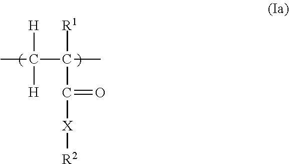

with
R¹ identical or different and represented by H and/or a non-branched chain or branched C₁₋C₄ alkyl group;
X identical or different and represented by NH—(CₙH₂ₙ) with n=1, 2, 3 or 4 and/or O—(CₙH₂ₙ) with n=1, 2, 3 or 4 and/or by a unit not present;
R² identical or different and represented by OH, SO₃H, PO₃H₂, O—PO₃H₂ and/or para-substituted C₆H₄—SO₃H, with the proviso that, if X is a unit not present, R² is represented by OH;

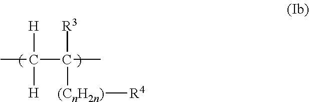

with
R³ identical or different and represented by H and/or a non-branched chain or branched C₁-C₄ alkyl group;
n=0, 1, 2, 3 or 4
R⁴ identical or different and represented by SO₃H, PO₃H₂, O—PO₃H₂ and/or para-substituted C₆H₄—SO₃H;

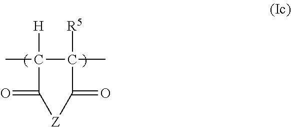

with
R⁵ identical or different and represented by H and/or a non-branched chain or branched C₁-C₄ alkyl group;
Z identical or different and represented by 0 and/or NH;

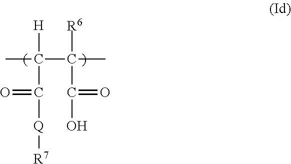

with
R⁶ identical or different and represented by H and/or a non-branched chain or branched C₁-C₄ alkyl group;
Q identical or different and represented by NH and/or O;
R⁷ identical or different and represented by H, (CₙH₂ₙ)—SO₃H with n=0, 1, 2, 3 or 4, preferably 1, 2, 3 or 4, (CₙH₂ₙ)—OH with n=0, 1, 2, 3 or 4, preferably 1, 2, 3 or 4; (CₙH₂ₙ)—PO₃H₂ with n=0, 1, 2, 3 or 4, preferably 1, 2, 3 or 4, (CₙH₂ₙ)—OPO₃H₂ with n=0, 1, 2, 3 or 4, preferably 1, 2, 3 or 4, (C₆H₄)—SO₃H, (C₆H₄)—PO₃H₂, (C₆H₄)—OPO₃H₂ and/or (CₘH₂ₘ)ₑ—O-(A′O)_{α}—R⁹ with m=0, 1, 2, 3 or 4, preferably 1, 2, 3 or 4, e=0, 1, 2, 3 or 4, preferably 1, 2, 3 or 4, A′=C_{x′}H_{2x′} with x′=2, 3, 4 or 5 and/or CH₂C(C₆H₅)H—, α=an integer from 1 to 350 with R⁹ identical or different and represented by a non-branched chain or branched C₁-C₄ alkyl group.

Typically, methacrylic acid, acrylic acid, maleic acid, maleic anhydride, a monoester of maleic acid or a mixture of a plurality of these components is used as the acid monomer.

In special cases, an ester compound which (in particular as a structural unit incorporated into the copolymer) can be converted by alkaline hydrolysis (e.g. in the alkaline medium of the concrete) into the corresponding acid compound can also be used as the acid monomer. Usually, not exclusively such an ester compound capable of alkaline hydrolysis but typically the ester compound together with an acid monomer which has free acid functions (e.g. acrylic acid) is used as the acid monomer.

As a rule, that polyether macromonomer structural unit of the copolymer which arises from the reaction of the polyether macromonomer is in accordance with one of the general formulae (IIa), (IIb) and/or (IIc)

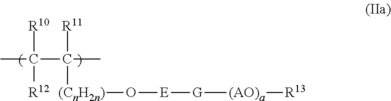

with
R¹⁰, R¹¹ and R¹² in each case identical or different and, independently of one another, represented by H and/or a non-branched chain or branched C₁-C₄ alkyl group;
E identical or different and represented by a non-branched chain or branched C₁-C₆ alkylene group, a cyclohexylene group, CH₂—C₆H₁₀, ortho-, meta- or para-substituted C₆H₄ and/or a unit not present;
G identical or different and represented by O, NH and/or CO—NH, with the proviso that, if E is a unit not present, G is also present as a unit not present;
A identical or different and represented by CₓH₂ₓ with x=2, 3, 4 and/or 5 (preferably x=2) and/or CH₂CH(C₆H₅);
n identical or different and represented by 0, 1, 2, 3, 4 and/or 5;
a identical or different and represented by an integer from 2 to 350 (preferably 10-200);
R¹³ identical or different and represented by H, a non-branched chain or branched C₁-C₄ alkyl group, CO—NH₂, and/or COCH₃;

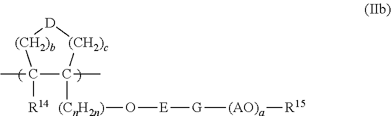

with
R¹⁴ identical or different and represented by H and/or a non-branched chain or branched C₁-C₄ alkyl group;
E identical or different and represented by a non-branched chain or branched C₁-C₆ alkylene group, a cyclohexylene group, CH₂—C₆H₁₀, ortho-, meta- or para-substituted C₆H₄ and/or by a unit not present;
G identical or different and represented by a unit not present, O, NH and/or CO—NH, with the proviso that, if E is a unit not present, G is also present as a unit not present;
A identical or different and represented by CₓH₂ₓ with x=2, 3, 4 and/or 5 and/or CH₂CH(C₆H₅);
n identical or different and represented by 0, 1, 2, 3, 4 and/or 5
a identical or different and represented by an integer from 2 to 350;
D identical or different and represented by a unit not present, NH and/or O, with the proviso that if D is a unit not present: b=0, 1, 2, 3 or 4 and c=0, 1, 2, 3 or 4, where b+c=3 or 4, and
with the proviso that if D is NH and/or O: b=0, 1, 2 or 3, c=0, 1, 2 or 3, where b+c=2 or 3;
R¹⁵ identical or different and represented by H, a non-branched chain or branched C₁-C₄ alkyl group, CO—NH₂ and/or COCH₃;

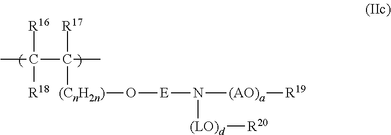

with
R¹⁶, R¹⁷ and R¹⁸ in each case identical or different and, independently of one another, represented by H and/or a non-branched chain or branched C₁-C₄ alkyl group;
E identical or different and represented by a non-branched chain or branched C₁-C₆ alkylene group, preferably a C₂-C₅ alkylene group, a cyclohexylene group, CH₂—C₆H₁₀, ortho-, meta- or para-substituted C₆H₄ and/or by a unit not present; preferably E is selected from a non-branched chain or branched C₁-C₆ alkylene group, preferably a C₂-C₆ alkylene group, a cyclohexylene group, CH₂—C₆H₁₀ and/or ortho-, meta- or para-substituted C₆H₄;
A identical or different and represented by CₓH₂ₓ with x=2, 3, 4 and/or 5 and/or CH₂CH(C₆H₅);
n identical or different and represented by 0, 1, 2, 3, 4 and/or 5;
L identical or different and represented by CₓH₂ₓ with x=2, 3, 4 and/or 5 and/or CH₂—CH(C₆H₅);
a identical or different and represented by an integer from 2 to 350;
d identical or different and represented by an integer from 1 to 350;
R¹⁹ identical or different and represented by H and/or a non-branched chain or branched C₁-C₄ alkyl group,
R²⁰ identical or different and represented by H and/or a non-branched chain C₁-C₄ alkyl group.

Vinylated methyl polyethylene glycol, alkoxylated isoprenol and/or alkoxylated hydroxybutyl vinyl ether and/or alkoxylated (meth)allyl alcohol having preferably in each case an arithmetic mean number of 4 to 340 oxyalkylene groups is preferably used as the polyether macromonomer.

A vinylically unsaturated compound which is reacted by polymerization and thus produces a structural unit in the copolymer which is present according to the general formulae (IIIa) and/or (IIIb),

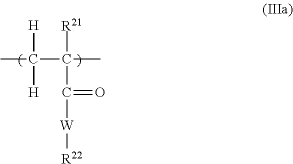

with
R²¹ identical or different and represented by H and/or a non-branched chain or branched C₁-C₄ group;
W identical or different and represented by O and/or NH;
R²² identical or different and represented by a branched or non-branched chain C₁-C₅ monohydroxyalkyl group;

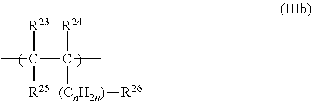

with
R²³, R²⁴ and R²⁵ in each case identical or different and, in each case independently, represented by H and/or a non-branched chain or branched C₁-C₄ alkyl group;
n identical or different and represented by 0, 1, 2, 3 and/or 4;
R²⁶ identical or different and represented by (C₆H₅), OH and/or —COCH₃,
   may be present as a further component of the starting reaction composition.

In general, polyether macromonomers are used as components of the starting reaction composition in an amount per mole of acid monomer such that an arithmetic mean molar ratio of acid monomer structural units to polyether macromonomer structural units of 20:1 to 1:1, preferably of 12:1 to 1:1, is established in the copolymer formed.

In a preferred embodiment, at least 45 mol %, but preferably at least 80 mol %, of all structural units of the copolymer are present as acid monomer structural units and polyether macromonomer structural units.

A chain regulator, which is preferably present in dissolved form, may be present as a further component of the starting reaction composition.

The monomeric starting materials and/or the initiator may be initially introduced in the form of their aqueous solutions as components of the starting reaction composition.

The invention furthermore relates to a copolymer which can be prepared by the process described above.

The present invention furthermore relates to the use of this copolymer as a dispersant for hydraulic binders.

Below, the invention is to be described in more detail with reference to working examples.

In all examples, a reactor type from Protensive Limited, which is described in WO00/48728, was used.

### PREPARATION EXAMPLE

For the preparation of the polymer, a reactor cascade consisting of three reactors of the reactor type from Protensive Limited was used. The diameter of the respective disc was 20 cm. For the reaction, a monomer solution consisting of 57.5% of macromonomer (prepared by ethoxylation of 4-hydroxybutyl vinyl ether with 22 mol of EO), 6.4% of acrylic acid (99.5% strength), 1.6% of KOH (40% strength), 0.1% of 3-mercaptopropionic acid, 33.9% of water and 0.5% of initiator (Irgarcure 500, Ciba—chemically: mixture of 1-hydroxycyclohexyl phenyl ketone and benzophenone in the molar ratio of 1:1) was prepared in a feed container and metered through the opening in the housing centrally onto the disc of the first reactor. The flow rate was 1 ml/s and the speed of rotation was 800 revolutions/min. The thin film forming on the rotating disc was irradiated with UV light (wavelength between 280 and 400 nm). The reaction solution emerging from the first reactor was then metered in succession onto the reaction surfaces of the second and third reactor of the cascade, on which in each case the process described on the first disc was repeated with the same parameters. The temperature of the reaction surface was about 22° C. After leaving the disc of the third reactor, the reaction mixture was collected and then analyzed.

The aqueous solution of a copolymer having an average molecular weight of Mw=39 700 g/mol and a polydispersity of 1.80 was obtained. The yield of polymer in comparison with unsaturated alcohol ethoxylate not incorporated in the copolymerized units was 75% (determined by gel permeation chromatography).

For evaluating the copolymer solution, a minimortar test was carried out. The experimental procedure is described in Use Example 1. In the test, the water reduction capacity and the maintenance of the flowability over a period of 30 min were to be determined.

### USE EXAMPLE 1

80 g of Portland cement (CEM I 42,5 R, Bernburg) were stirred with 86.45 g of sand having a fine fraction of particles up to 1 mm and 28.16 g of water, which the products according to the invention or the comparative products contained in dissolved form. Immediately after the preparation of the mortar mix, the slump and the change thereof as a function of time over a period of 30 minutes were determined.

The results are shown in Table 1.

| | Solid | Dose | Slump (mm) | Slump (mm) |
|---|---|---|---|---|
| Admixture | (% by weight) | (% by weight) | 0 min | 30 min |
| Example 1 | 10 | 0.175 | 145 | 100 |
| Example 1 | 10 | 0.20 | 160 | 124 |

w/c = 0.37

1. Process for the preparation of copolymers containing acid monomer structural units and polyether macromonomer structural units, which is carried out in a continuous mode of operation in a reactor which has
α) a body B rotating about an axis of rotation and having a reaction surface,
β) a metering system and
γ) a device for irradiating the reaction surface,
i) the components of a starting reaction composition being applied individually and/or as a mixture with the aid of the metering system in a thin film on an inner region of the reaction surface of the rotating body B so that the thin film flows over the reaction surface of the rotating body B to an outer region of the reaction surface of the rotating body B, the thin film on the reaction surface being electromagnetically irradiated by means of the device for the irradiation of the reaction surface,
ii) the thin film leaving the reaction surface as a reaction composition which has copolymer containing acid monomer structural units and polyether macromonomer structural units and
iii) the reaction composition being collected after leaving the reaction surface,
an acid monomer, a polyether macromonomer and a photoinitiator being present as components of the starting reaction composition and the temperature of the reaction surface being 0 to 60° C.

2. Process according to claim 1, wherein the reaction surface extends to further rotating bodies so that, before leaving the reaction surface of the rotating body B, the reaction composition reaches the reaction surface of at least one further rotating body having the reaction surface.

3. Process according to claim 1, wherein the rotating body B is in the form of a rotating disc which has the reaction surface at the top and where the components of the starting reaction composition are applied individually and/or as a mixture with the aid of the metering system in a middle region as a thin film, and a wall surrounding the rotating disc is present, by means of which the reaction composition is collected after leaving the reaction surface.

4. Process according to any of claim 1, wherein the temperature of the reaction surface is between 5 and 45° C., optionally between 10 and 30° C.

5. Process according to claim 1, wherein the photoinitiator is present as a mixture of 1-hydroxycyclohexyl phenyl ketone and benzophenone.

6. Process according to claim 1, wherein 0.1 to 0.0005 mol, optionally 0.01 to 0.1 mol, of photoinitiator is used per mole of acid monomer.

7. Process according to claim 1, wherein the device for the irradiation of the reaction surface is present as a UV lamp, by means of which the thin film on the reaction surface is electromagnetically irradiated with light in a wavelength range from 10 to 700 nm, optionally 280 to 400 nm.

8. Process according to claim 1, wherein a layer thickness of the thin film applied by means of the metering system of 10 μm to 1.0 mm, optionally of 100 to 200 μm, and a frequency-average residence time of the components of the starting reaction composition on the reaction surface of 0.1 to 20 seconds, optionally of 1 to 10 seconds, are established as process parameters.

9. Process according to claim 1, wherein the acid monomer structural unit of the copolymer, arising from the reaction of the acid monomer and in accordance with one of the general formulae (Ia), (Ib), (Ic) and/or (Id), is 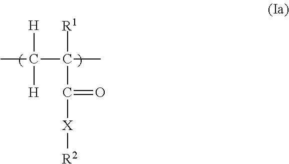
with
R¹ identical or different and represented by H and/or a non-branched chain or branched C₁-C₄ alkyl group;
X identical or different and represented by NH—(CₙH₂ₙ) with n=1, 2, 3 or 4 and/or O—(CₙH₂ₙ) with n=1, 2, 3 or 4 and/or by a unit not present;
R² identical or different and represented by OH, SO₃H, PO₃H₂, O—PO₃H₂ and/or para-substituted C₆H₄—SO₃H, with the proviso that, if X is a unit not present, R² is represented by OH; 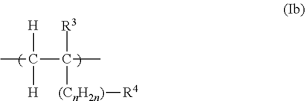
with
R³ identical or different and represented by H and/or a non-branched chain or branched C₁-C₄ alkyl group;
n=0, 1, 2, 3 or 4
R⁴ identical or different and represented by SO₃H, PO₃H₂, O—PO₃H₂ and/or para-substituted C₆H₄—SO₃H: 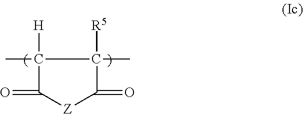
with
R⁵ identical or different and represented by H and/or a non-branched chain or branched C₁-C₄ alkyl group;
Z identical or different and represented by 0 and/or NH; 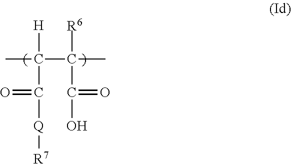
with
R⁶ identical or different and represented by H and/or a non-branched chain or branched C₁-C₄ alkyl group;
Q identical or different and represented by NH and/or O;
R⁷ identical or different and represented by H, (CₙH₂ₙ)—SO₃H with n=0, 1, 2, 3 or 4, (CₙH₂ₙ)—OH with n=0, 1, 2, 3 or 4; (CₙH₂ₙ)—PO₃H₂ with n=0, 1, 2, 3 or 4, (CₙH₂ₙ)—OPO₃H₂ with n=0, 1, 2, 3 or 4, (C₆H₄)—SO₃H, (C₆H₄)—PO₃H₂, (C₆H₄)—OPO₃H₂ and/or (CₘH₂ₘ)ₑ—O-(A′O)_{α}—R⁹ with m=0, 1, 2, 3 or 4, e=0, 1, 2, 3 or 4, A′=C_{x′}H_{2x′} with x′=2, 3, 4 or 5 and/or CH₂C(C₆H₅)H—, α=an integer from 1 to 350 with R⁹ identical or different and represented by a non-branched chain or branched C₁-C₄ alkyl group.

10. Process according to claim 1, wherein the acid monomer used is methacrylic acid, acrylic acid, maleic acid, maleic anhydride, a monoester of maleic acid or a mixture of a plurality of these components.

11. Process according to claim 1, wherein the polyether macromonomer structural unit of the copolymer, arising from the reaction of the polyether macromonomer and in accordance with one of the general formulae (IIa), (IIb) and/or (IIc), is 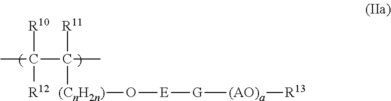
with
R¹⁰, R¹¹ and R¹² in each case identical or different and, independently of one another, represented by H and/or a non-branched chain or branched C₁-C₄ alkyl group;
E identical or different and represented by a non-branched chain or branched C₁-C₆ alkylene group, a cyclohexyl group, CH₂—C₆H₁₀, ortho-, meta- or para-substituted C₆H₄ and/or a unit not present;
G identical or different and represented by O, NH and/or CO—NH, with the proviso that, if E is a unit not present, G is also present as a unit not present;
A identical or different and represented by CₓH₂ₓ with x=2, 3, 4 and/or 5 (optionally wherein x=2) and/or CH₂CH(C₆H₅);
n identical or different and represented by 0, 1, 2, 3, 4 and/or 5;
a identical or different and represented by an integer from 2 to 350 (optionally 10-200);
R¹³ identical or different and represented by H, a non-branched chain or branched C₁-C₄ alkyl group, CO—NH₂, and/or COCH₃; 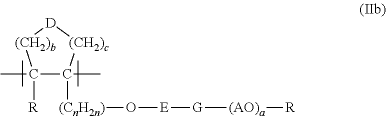
with
R¹⁴ identical or different and represented by H and/or a non-branched chain or branched C₁-C₄ alkyl group;
E identical or different and represented by a non-branched chain or branched C₁-C₆ alkylene group, a cyclohexyl group, CH₂—C₆H₁₀, ortho-, meta- or para-substituted C₆H₄ and/or by a unit not present;
G identical or different and represented by a unit not present, O, NH and/or CO—NH, with the proviso that, if E is a unit not present, G is also a unit not present;
A identical or different and represented by CₓH₂ₓ with x=2, 3, 4 and/or 5 and/or CH₂CH(C₆H₅);
n identical or different and represented by 0, 1, 2, 3, 4 and/or 5
a identical or different and represented by an integer from 2 to 350;
D identical or different and represented by a unit not present, NH and/or O, with the proviso that if D is a unit not present: b=0, 1, 2, 3 or 4 and c=0, 1, 2, 3 or 4, where b+c=3 or 4, and
with the proviso that if D is NH and/or O: b=0, 1, 2 or 3, c=0, 1, 2 or 3, where b+c=2 or 3;
R¹⁵ identical or different and represented by H, a non-branched chain or branched C₁-C₄ alkyl group, CO—NH₂ and/or COCH₃; 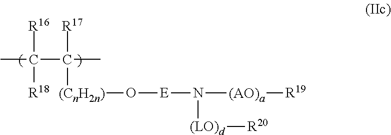
with
R¹⁸, R¹⁷ and R¹⁸ in each case identical or different and, independently of one another, represented by H and/or a non-branched chain or branched C₁-C₄ alkyl group;
E identical or different and represented by a non-branched chain or branched C₁-C₆ alkylene group, a cyclohexyl group, CH₂—C₆H₁₀, ortho-, meta- or para-substituted C₆H₄ and/or by a unit not present;
A identical or different and represented by CₓH₂ₓ with x=2, 3, 4 and/or 5 and/or CH₂CH(C₆H₅);
n identical or different and represented by 0, 1, 2, 3, 4 and/or 5;
L identical or different and represented by CₓH₂ₓ with x=2, 3, 4 and/or 5 and/or CH₂—CH(C₆H₅),
a identical or different and represented by an integer from 2 to 350;
d identical or different and represented by an integer from 1 to 350;
R¹⁹ identical or different and represented by H and/or a non-branched chain or branched C₁-C₄ alkyl group,
R²⁰ identical or different and represented by H and/or a non-branched chain C₁-C₄ alkyl group.

12. Process according to claim 1, wherein the polyether macromonomer used is vinylated methylpolyethylene glycol, alkoxylated isoprenol and/or alkoxylated hydroxybutyl vinyl ether and/or alkoxylated (meth)allyl alcohol having optionally in each case an arithmetic mean number of 4 to 340 oxyalkylene groups.

13. Process according to claim 1, wherein a vinylically unsaturated compound which is reacted by polymerization and thus produces a structural unit in the copolymer which is present according to the general formulae (IIIa) and/or (IIIb), 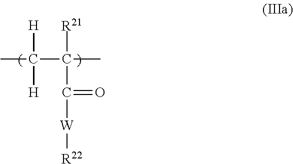
with
R²¹ identical or different and represented by H and/or a non-branched chain or branched C₁-C₄ group;
W identical or different and represented by O and/or NH;
R²² identical or different and represented by a branched or non-branched chain C₁-C₅ monohydroxyalkyl group; 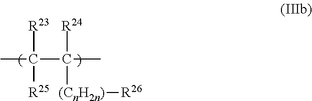
with
R²³, R²⁴ and R²⁵ in each case identical or different and, in each case independently, represented by H and/or a non-branched chain or branched C₁-C₄ alkyl group;
n identical or different and represented by 0, 1, 2, 3 and/or 4;
R²⁶ identical or different and represented by (C₆H₅), OH and/or —COCH₃,
is present as a component of the starting reaction composition.

14. Process according to claim 1, wherein polyether macromonomers are used as components of the starting reaction composition in an amount per mole of acid monomer such that an arithmetic mean molar ratio of acid monomer structural units to polyether macromonomer structural units of 20:1 to 1:1, optionally of 12:1 to 1:1, is established in the copolymer formed.

15. Process according to claim 1, wherein altogether at least 45 mol %, but optionally at least 80 mol %, of all structural units of the copolymer are present as acid monomer structural units and polyether macromonomer structural units.

16. Process according to claim 1, wherein a chain regulator, which is optionally present in dissolved form, is present as a component of the starting reaction composition.

17. Process according to claim 1, wherein the monomeric starting materials and/or free radical polymerization initiator are initially introduced in the form of their aqueous solutions as components of the starting reaction composition.

18. Copolymer which is prepared by the process according to claim 1.

19. (canceled)

20. Process comprising mixing a copolymer according to claim 18 as a dispersant with hydraulic binder and water.
